(19) United States
(12) Patent Application Publication
(10) Pub. No.: US 2018/0370530 A1
(43) Pub. Date: Dec. 27, 2018

(54) PREDICTING APPARATUS, PREDICTION SYSTEM, PREDICTION METHOD, AND PREDICTION PROGRAM

(71) Applicant: Pioneer Corporation, Bunkyo-ku, Tokyo (JP)

(72) Inventor: Masao ISHIKAWA, Saitama (JP)

(21) Appl. No.: 16/065,902

(22) PCT Filed: Dec. 25, 2015
(86) PCT No.: PCT/JP2015/086435

§ 371 Date: Jun. 25, 2018

(51) Int. Cl. B60W 30/095; H04W 4/46; B60W 50/14

(52) U.S. Cl. CPC B60W 30/095; H04W 4/46; B60W 2050/146; B60W 2050/143; B60W 50/14

(57) ABSTRACT

A predicting apparatus (100) includes an acquiring unit (101) that acquires a movement history of another vehicle from the other vehicle; a predicting unit (102) that predicts a behavior of the other vehicle based on the movement history; and an output unit (103) that outputs driving support information based on the prediction. The acquiring unit (101) acquires the movement history from the other vehicle in a communication range of inter-vehicle communication, and the predicting unit (102) predicts the behavior of the other vehicle in the communication range of the inter-vehicle communication. The acquiring unit (101) acquires information usable in the prediction of the behavior of the other vehicle, and the predicting unit (102) predicts the behavior of the other vehicle using plural pieces of information together with the movement history.

### TECHNICAL FIELD

The present invention relates to a predicting apparatus, a prediction system, a prediction method, and a prediction program.

### BACKGROUND ART

Conventionally, a technique has been disclosed according to which route information is acquired from another vehicle and a behavior of the other vehicle is predicted based on the acquired route information (see, e.g., Patent Document 1 below).

Patent Document 1: Japanese Laid-Open Patent Publication No. 2011-242887

### DISCLOSURE OF INVENTION

### Problem to be Solved by the Invention

With the conventional technique, one example of a problem is that the behavior of the other vehicle cannot be predicted when the other vehicle does not set a route.

### Means for Solving Problem

To solve the problems above and achieve an object, a predicting apparatus according to the invention of claim 1 includes an acquiring unit that acquires a movement history of a mobile object from the mobile object; a predicting unit that predicts a behavior of the mobile object and a degree of certainty of the behavior, based on the movement history; and an output unit that outputs driving support information that is based on the behavior and the degree of certainty.

Further, a prediction system according to the invention of claim 8 includes a user's vehicle; another vehicle; and a server, wherein the user's vehicle, the other vehicle, and the server are communicably connected to each other, and the server includes an acquiring unit that acquires a current position of the user's vehicle and a movement history of the other vehicle; a predicting unit that predicts a behavior of the other vehicle and a degree of certainty of the behavior, based on the current position and the movement history; and an output unit that outputs the user's vehicle, driving support information that is based on the behavior and the degree of certainty.

Further, a prediction method according to the invention of claim 9 and executed by a predicting apparatus, includes acquiring step of acquiring a movement history of a mobile object from the mobile object; a predicting step of predicting a behavior of the mobile object and a degree of certainty of the behavior, based on the movement history; and an output step of outputting driving support information that is based on the behavior and the degree of certainty.

Further, a non-transitory, computer-readable recording medium according to the invention of claim 8 stores therein a prediction program that causes a computer to execute the prediction method according to claim 9.

### BRIEF DESCRIPTION OF DRAWINGS

FIG. 1 is a block diagram of an example of a functional configuration of a predicting apparatus according to an embodiment

FIG. 2 is a flowchart of an example of a procedure for a process executed by the predicting apparatus according to the embodiment;

FIG. 3 is a block diagram of an example of a hardware configuration of a navigating apparatus according to Example of the predicting apparatus;

FIG. 4 is a chart of an example of information acquired from another vehicle by the navigating apparatus according to Example;

FIG. 5 is a chart for explaining an example of communication by inter-vehicle communication according to Example;

FIG. 6 is a diagram for explaining an example of prediction of a behavior of another vehicle according to Example;

FIG. 7 is a chart for explaining an example of driving support corresponding to the degree of certainty of the prediction according to Example;

FIG. 8A is a flowchart of an example of a prediction process executed by a user's vehicle according to Example;

FIG. 8B is a flowchart of an example of a process executed by the other vehicle, according to the prediction process of Example;

FIG. 9 is a diagram of an example of a system configuration of the predicting apparatus according to Another Example; and

FIG. 10 is a diagram of an example of a functional configuration of a system of the predicting apparatus according to Another Example.

### BEST MODE(S) FOR CARRYING OUT THE INVENTION

### Embodiment

Preferred embodiments of a predicting apparatus, a prediction system, a prediction method, and a prediction program according to the present invention will be described in detail with reference to the accompanying drawings. In the following description, “user's vehicle” is a vehicle (a mobile object) such as a car equipped with the predicting apparatus and an “other vehicle” is a vehicle (mobile object) that is traveling near the user's vehicle such as, for example, in front of the user's vehicle.

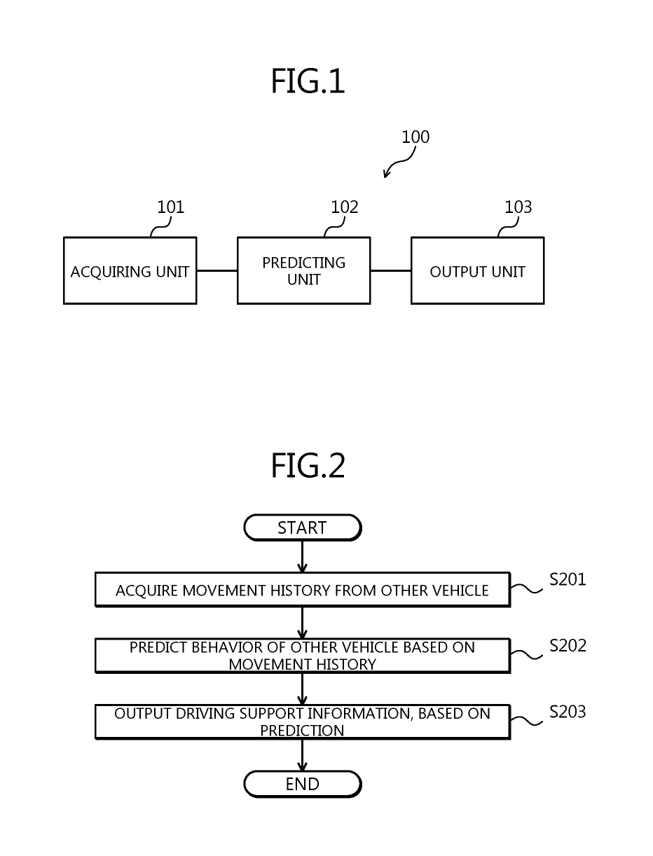

FIG. 1 is a block diagram of an example of a functional configuration of the predicting apparatus according to the embodiment. The predicting apparatus 100 includes an acquiring unit 101, a predicting unit 102, and an output unit 103.

The acquiring unit 101 acquires a movement history of the other vehicle. The movement history is acquired directly from the other vehicle using inter-vehicle communication. A communications unit for the inter-vehicle communication transmits and receives information with other vehicles within a communication range of the user's vehicle. In this case, the user's vehicle transmits by broadcasting vehicle information to an unspecified number of other vehicles, and receives from the other vehicles, vehicle information transmitted by broadcasting. The vehicle information includes identification information related to the vehicle (vehicle ID), latitude and longitude information indicating the location of the vehicle, vehicle speed information indicating the traveling speed of the vehicle, travel direction information indicating the moving direction of the vehicle, and traveling road information indicating the road number (including the lane number) of the road on which the vehicle currently travels. Plural vehicles (the other vehicles) can be identified and the movement history can be identified for each of the other vehicles, based on the plural pieces of received vehicle information.

Using, for example, the inter-vehicle communication, the acquiring unit 101 of the embodiment can acquire the movement history from another vehicle that is currently traveling in front of the user's vehicle. The movement history of the other vehicle can be acquired from the other vehicle, by the user's vehicle through a network to which the user's vehicle and the other vehicle are connected for communication, without limitation to the inter-vehicle communication by which the user's vehicle and the other vehicle directly communicate with each other.

With the inter-vehicle communication, the movement history can be acquired easily from the other vehicles within a predetermined communication range centered on the user's vehicle. Using the inter-vehicle communication, the user's vehicle can narrow down and acquire the movement history of the other vehicles in the vicinity of the user's vehicle without designating the other vehicles.

Each of the other vehicles retains a route on the roads on which the other vehicle traveled in the past. The route is past movement history of the other vehicle and includes information such as the latitude and the longitude, the speed, and the time.

The other vehicles can retain ancillary information that relates to the routes in the past as the movement history. Examples of the ancillary information include, for example, a history of visits to facilities and places (convenience stores, supermarkets, gasoline stations, and parking lots that are frequently used), favorite spots (such as registered places, and logos of the facilities that are caused to be displayed on a route display screen when visits were made thereto in the past), the entrances of parking lots (automatic parking memory location information), and information related to operation of direction indicators. The acquiring unit 101 can acquire these pieces of ancillary information retained by the other vehicles, together with the movement history.

The acquiring unit 101 can also acquire current driving information of the other vehicles. The other vehicles can acquire pieces of information as driving information, such as a remaining gasoline amount, a continuous driving time period, information related to sudden braking (such as presence or absence of any sudden braking, and the degree thereof), collected information related to the conversation of the passengers in the vehicle, and the state of automatic driving. The acquiring unit 101 can acquire these pieces of driving information. The continuous driving time period may be information related to a case where continuous driving was conducted in the past, without limitation to the information related to the current continuous driving.

The predicting unit 102 predicts the behavior of the other vehicle based on the movement history of the other vehicle acquired by the acquiring unit 101. The output unit 103 outputs driving support information that supports safe driving of the user's vehicle, based on the prediction by the predicting unit 102. For example, the driving support information can be output using screen display and sound, to an operator (driver) who drives the user's vehicle. In addition, the driving support information can be output as control information for a vehicle control unit of the user's vehicle.

The predicting unit 102 predicts the behavior of the other vehicle traveling in front of the user's vehicle, enabling the user's vehicle travel with safe driving. For example, the acquiring unit 101 acquires from the other vehicle, the movement history for the past indicating that “this vehicle made a left turn at the next intersection”, and the predicting unit 102 thereby predicts the behavior of the other vehicle at the next intersection (such as, for example, reduction in speed, and a change of the traveling lane for a left turn).

Even when the other vehicle operates without setting a route, the movement history for the past can be acquired from the other vehicle. Thus, the behavior of the other vehicle can thereby be predicted in a case where the other vehicle does not set a route. In addition, even when the other vehicle moves without setting a place to visit (such as, for example, a convenience store or a gasoline station), the behavior of the other vehicle including the places to be visited can be predicted based on the movement history for the past. Even when operations of the direction indicators of the other vehicle are inconsistent (such as, for example, a delayed operation of the direction indicator at an intersection or no operation of the direction indicator at an intersection), the direction of the turn at the intersection made by the other vehicle in the past can be predicted based on the movement history for the past.

When the user's vehicle approaches the next intersection, the output unit 103 uses display on a screen, a sound, and the like to output the behavior of the other vehicle (such as, for example, reduction of the speed, and a change of the traveling lane for a left turn) as the predicted driving support information. As a result, notification of the behavior of the other vehicle can be given in advance to the driver of the user's vehicle. The vehicle control unit uses the driving support information as information for automatic control such as a reduction of the speed, and can thereby reduce the speed by automatic braking or the like.

The output unit 103 can change the contents of the driving support according to a degree of certainty (the probability) of the driving support information, based on the degree of certainty of the prediction executed by the predicting unit 102. For example, when the degree of certainty of the prediction is high, the output unit 103 actively notifies the driver of the content of the prediction using plural outputs (such as, for example, the screen display and the sound output) and of the predicted behavior. On the other hand, the output unit 103 notifies the driver of the content of the prediction at a level of alerting, and as the degree of certainty becomes lower, to a lower extent that the output is executed by either the screen display or the sound output. Regarding the driving support information for the vehicle control unit, the degree of the vehicle control can also be varied, for example, as follows: when the degree of the certainty of the prediction is high, the vehicle control is executed to an extent that the driver can perceive the vehicle control (such as, for example, reduction of the speed by braking using the brake); the vehicle control is executed to an extent that it is more difficult for the driver to perceive the vehicle control as the degree of certainty becomes lower; and no vehicle control is executed at the lowest degree of certainty (however, radar detection sessions other than the vehicle control are executed).

The above driving information is also used to predict the behavior of the other vehicle. The prediction process executed using the driving information can be executed by the other vehicle or the user's vehicle. For example, the remaining gasoline amount itself is always detected by the other vehicle. In this case, the acquiring unit 101 of the user's vehicle acquires the remaining gasoline amount from the other vehicle, the predicting unit 102 thereof predicts whether the other vehicle will visit the next gasoline station on the traveling route of the user's vehicle, based on the acquired remaining gasoline amount information, and the output unit 103 outputs the result of the prediction to the driver of the user's vehicle. When the other vehicle is configured to execute the prediction process, the acquiring unit 101 acquires from the other vehicle, information related to a gasoline station for the other vehicle to visit as predicted by the other vehicle, and the output unit 103 outputs the acquired information.

The predicting unit 102 may predict the behavior of the other vehicle using not only the movement history but also in combination with the driving information. The precision of the prediction can thereby be improved.

FIG. 2 is a flowchart of an example of a procedure for a process executed by the predicting apparatus according to the embodiment. FIG. 2 depicts an example of a prediction process of the behavior of the other vehicle executed by the predicting apparatus 100 of the user's vehicle. The predicting apparatus 100, by the acquiring unit 101, acquires the movement history from the other vehicle (step S201). This movement history includes the driving information.

The predicting apparatus 100, by the predicting unit 102, predicts the behavior of the other vehicle based on the movement history (step S202). The predicting apparatus 100 outputs, by the output unit 103, the driving support information that is based on the prediction (step S203) and the above operations come to an end.

For example, at step S201, the acquiring unit 101 acquires the movement history for the past indicating “this vehicle made a left turn at the next intersection” from the other vehicle and, at step S202, the predicting unit 202 thereby predicts the behavior of the other vehicle at the next intersection (such as, for example, reduction of the speed, and a change of the traveling lane for a left turn). At step S203, when the user's vehicle approaches the next intersection, the output unit 103 outputs the behavior of the other vehicle as the predicted driving support information (such as, for example, reduction of the speed, and a change of the traveling lane for a left turn) by display on the screen, using sound, and the like.

In addition, at step S203, the output unit 103 outputs to the vehicle control unit, the prediction for a change of the lane of the other vehicle (such as, for example, a change of the lane to a lane on the left immediately before making a left turn) or reduction of the speed, as the driving support information. The vehicle control unit can execute vehicle control such as braking using the brake of the user's vehicle, in response to the predicted behavior of the other vehicle.

As another example, at step S201, the acquiring unit 101 of the user's vehicle acquires the remaining gasoline amount of the other vehicle and, at step S202, when the remaining gasoline amount of the other vehicle is equal to a predetermined remaining amount or less, the predicting unit 102 predicts that the other vehicle will visit the next gasoline station on the traveling route of the user's vehicle. At step S203, when the user's vehicle approaches the next gasoline station, the output unit 103 outputs the predicted behavior of the other vehicle as the driving support information (the behavior conducted when the other vehicle visits the next gasoline station) to the driver of the user's vehicle, by display on the screen, using sound, and the like. The output unit 103 outputs the driving support information to the vehicle control unit, enabling the vehicle control unit to execute vehicle control such as braking using the brake of the user's vehicle in response to the predicted behavior of the other vehicle.

As yet another example, when the other vehicle collects sound in the vehicle as conversation information, at step S201, the acquiring unit 101 of the user's vehicle acquires this conversation information. At step S202, the predicting unit 102 analyzes the sound of the conversation information and thereby predicts a place to be visited. For example, the predicting unit 102 analyzes the sound of a conversation stating “I would like to visit a convenience store” in the other vehicle and thereby predicts that the other vehicle will visit the next convenience store on the traveling route of the user's vehicle. At step S203, when the user's vehicle approaches the next convenience store, the output unit 103 outputs to the driver of the user's vehicle, the predicted behavior of the other vehicle (the behavior conducted when the other vehicle visits the next convenience store) by displaying the predicted behavior on the screen, using sound, and the like. The output unit 103 outputs the driving support information to the vehicle control unit, enabling the vehicle control unit to execute vehicle control such as braking using the brake of the user's vehicle in response to the predicted behavior of the other vehicle.

When the acquiring unit 101 acquires the current driving information together with the movement history for the past with respect to the other vehicle at step S201, at step S202, the predicting unit 102 can execute the prediction based on the movement history of the other vehicle in combination with the driving information. For example, at step S202, the movement history for the past is information indicating that “the other vehicle will visit the next gasoline station” while, when the remaining gasoline amount according to the current driving information is close to “full tank of gasoline” and no refilling of gasoline is necessary, the predicting unit 102 predicts that “the other vehicle will not visit the next gasoline station” and, at step S203, the output unit 103 executes no outputting.

In addition, at step S203, the output unit 103 may output a determination process executed by the predicting unit 102, that is, output indicating that, for the other vehicle, “although the other vehicle visited the next gasoline station in the past, the other vehicle does not need to refill any gasoline because the current remaining gasoline amount is a full tank of gasoline, and will not visit the next gasoline station”. The output unit 103 may be adapted not to output any driving support information based on the remaining gasoline amount to the vehicle control unit in the above case.

According to the above embodiment, the predicting apparatus outputs to the driver and the vehicle control unit, the driving support information that predicts the behavior of the other vehicle based on the movement history of the other vehicle. The driver and the vehicle control unit of the user's vehicle can thereby learn in advance the behavior of the other vehicle and can execute proper driving in response to the predicted behavior of the other vehicle before the predicted behavior of the other vehicle actually occurs (for example, avoid danger). For example, safe driving can be conducted with sufficient preparedness for the behavior of the other vehicle.

For example, even when the other vehicle moves without setting a route to a destination, or a place to visit, the behavior of the other vehicle moving without setting a route thereof can be predicted by acquiring the movement history for the past from the other vehicle. In addition, the behavior of the other vehicle can be predicted based on ancillary information included in the movement history of the other vehicle such as, for example, frequently used facilities, favorite spots, a logo of the facility caused to be displayed on the route display screen when the facility was visited in the past), entrances of parking lots, and information related to operation of the direction indicators. The behavior of the other vehicle can also be further predicted based on the current driving information combined with the movement history for the past of the other vehicle. The degree of certainty of the prediction of the behavior of the other vehicle can thereby be increased.

The driving support information can vary the extent of notification for the driver and the driving control unit corresponding to the degree of certainty of the prediction of the behavior of the other vehicle. When the degree of certainty of the prediction is high, for example, the driver can be actively be notified in advance that a dangerous state occurs while the driver is notified of the driving support information with lower activeness as the degree of the certainty of the prediction decreases. The driving support information can be adapted to not be notified at the lowest degree of certainty. Information related to a reliable prediction can thereby be presented to the driver and any complexity caused by presenting information related to unnecessary predictions is solved. The reliability of the predicting apparatus can thereby be improved.

### EXAMPLE

Example of the present invention will be described. In Example, an example will be described for a case where a navigating apparatus 300 is equipped on the user's vehicle and the navigating apparatus 300 executes the function of the predicting apparatus 100.

### Hardware Configuration of Navigating Apparatus 300

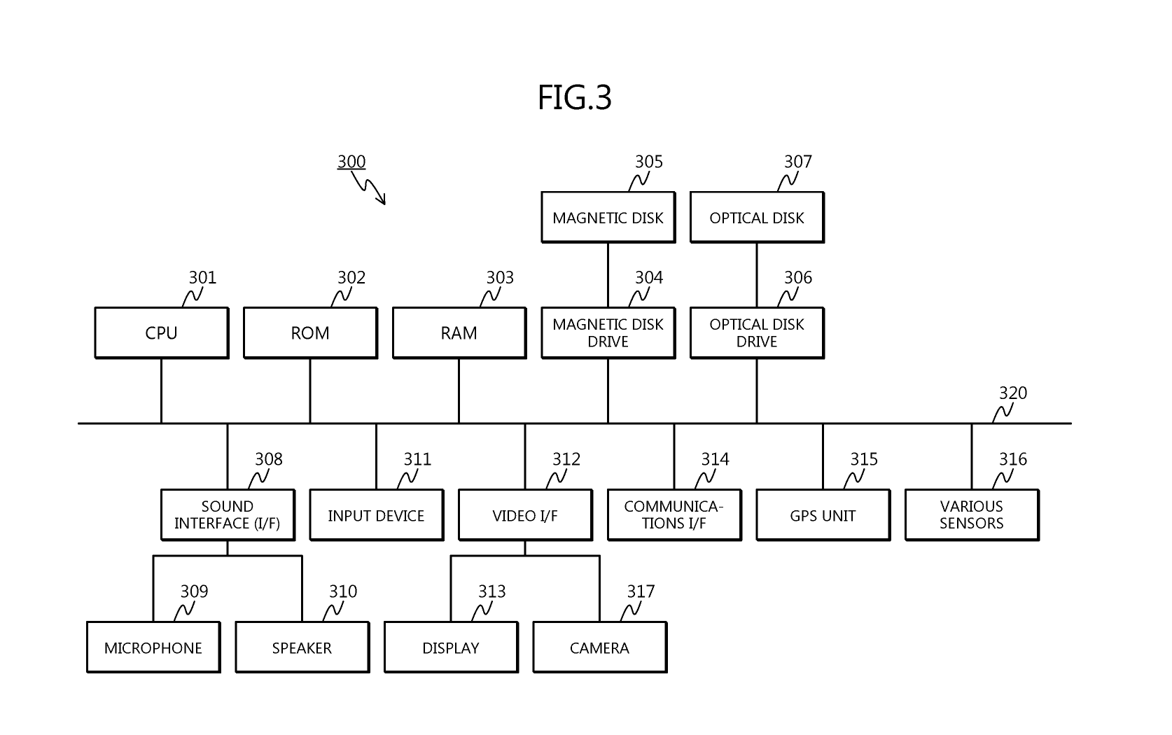

FIG. 3 is a block diagram of an example of a hardware configuration of the navigating apparatus according to Example of the predicting apparatus. In FIG. 3, the navigating apparatus 300 includes a CPU 301, a ROM 302, a RAM 303, a magnetic disk drive 304, a magnetic disk 305, an optical disk drive 306, an optical disk 307, a sound interface (I/F) 308, a microphone 309, a speaker 310, an input device 311, a video I/F 312, a display 313, a communications I/F 314, a GPS unit 315, various sensors 316, and a camera 317. The components 301 to 317 are connected to each other by a bus 320.

The CPU 301 supervises the control of the overall navigating apparatus 300. The ROM 302 has various programs recorded therein including a boot program and a prediction program. The RAM 303 is used as a work area of the CPU 301. The CPU 301 executes the various programs recorded in the ROM 302 using the RAM 303 as a work area, and thereby supervises the control of the overall navigating apparatus 300.

The magnetic disk drive 304 controls reading and writing of data with respect to the magnetic disk 305 under the control of the CPU 301. The magnetic disk 305 records data written thereto under the control of the magnetic disk drive 304. For example, a hard disk (HD) or a flexible disk (FD) can be used as the magnetic disk 305.

The optical disk drive 306 controls reading and writing of data with respect to the optical disk 307 under the control of the CPU 301. The optical disk 307 is a detachable recording medium from which data is read in under the control of the optical disk drive 306. A writable recording medium can also be used as the optical disk 307. An MO, a memory card, or the like can be used as the detachable recording medium in addition to the optical disk 307.

An example of information recorded on the magnetic disk 305 and the optical disk 307 includes map data, the vehicle information, road information, and the movement history. The map data is used when a route is searched for using a car navigation system, and is vector data including: background data indicating terrestrial objects (features) such as buildings, rivers, ground surface, and energy replenishing facilities; road shape data indicating the shapes of roads using links, nodes, and the like; and the like.

The audio I/F 308 is connected to the microphone 309 for inputting sound and the speaker 310 for outputting sound. Sound received by the microphone 309 is A/D-converted in the audio I/F 308. The microphone 309 is installed on, for example, the dashboard of the vehicle and a single microphone or plural microphones may be installed. The speaker 310 outputs sound formed by D/A-conversion of a predetermined sound signal at the audio I/F 308.

Examples of the input device 311 include a remote control, a keyboard, and a touch panel that each includes plural keys to input characters, numerical values, various types of instruction, and the like. The input device 311 may be realized by any one form of the remote control, the keyboard, and the touch panel and may be realized by plural forms thereof.

The video I/F 312 is connected to the display 313. The video I/F 312 includes, for example, a graphic controller that controls the overall display 313, a buffer memory such as a video RAM (VRAM) that temporarily records therein image information capable of being displayed in real time, a control IC that controls the display 313 based on image data output from the graphic controller, and the like.

The display 313 displays thereon icons, a cursor, menus, windows, or various types of data such as characters and images. For example, a TFT liquid crystal display or an organic EL display can be used as the display 313.

The camera 317 captures images that include roads outside the vehicle. The images may be a still image or a moving image. For example, an image outside the vehicle is captured by the camera 317 and the image is image-analyzed by the CPU 301 and is output to a recording medium such as the magnetic disk 305 or the optical disk 307 through the image I/F 312.

The communications I/F 314 is wirelessly connected to a network and functions as an interface of the navigating apparatus 300 and the CPU 301. Examples of a communication network functioning as the network include in-vehicle communication networks such as a CAN and a local interconnect network (LIN), a public line network, a mobile phone network, a dedicated short range communication (DSRC), a LAN, and a WAN. Examples of the communications I/F 314 include, for example, a public line connection module, an electric toll collection system (ETC, a registered trademark) unit, an FM tuner, and a vehicle information and communication system (VICS, a registered trademark)/a beacon receiver.

The GPS unit 315 receives an electromagnetic wave from a GPS satellite and outputs information that indicates the current position of the vehicle. The information output by the GPS unit 315 is used together with the output values of the various sensors 316 described later, for the calculation of the current position of the vehicle by the CPU 301. The information indicating the current position is information that identifies one point on map data such as, for example, the latitude and the longitude, and the altitude.

The various sensors 316, such as a vehicle speed sensor, an acceleration sensor, an angular speed sensor, an inclination sensor, and the like, output information to determine the location and the behavior of the vehicle. The output values of the various sensors 316 are used by the CPU 301 to calculate the current position of the vehicle and variations in speed and orientation.

The CPU 301 uses the programs and the data recorded in the ROM 302, the RAM 303, the magnetic disk 305, and the optical disk 307 depicted in FIG. 3 to execute predetermined programs to thereby realize functions related to the information processing of the acquiring unit 101 to the output unit 103 of the predicting apparatus 100 depicted in FIG. 1.

The communications I/F 314 in FIG. 3 is used to execute the inter-vehicle communication by short range communication via an electromagnetic wave with the other vehicle. This communication can realize a function of the acquiring unit 101 in FIG. 1. A function of the output unit 103 in FIG. 1 can be realized using the display 313 and the speaker 310 in FIG. 3, and the like. The communications I/F 314 may execute communication with the other vehicle through a network such as the Internet.

### Example of Information Acquired from Other Vehicle

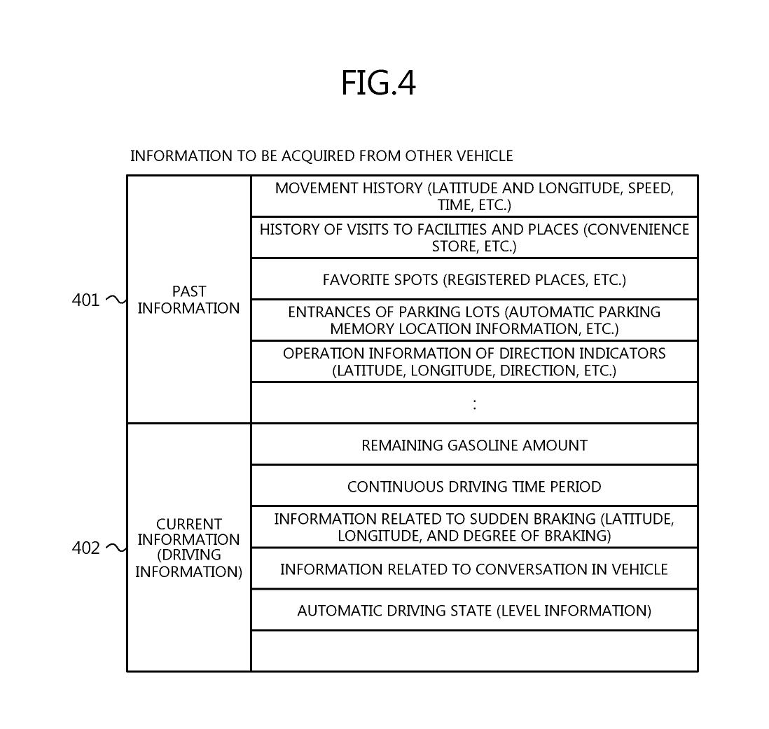

FIG. 4 is a chart of an example of the information acquired from another vehicle by the navigating apparatus according to Example. The navigating apparatus 300 uses the inter-vehicle communication and acquires from the other vehicle, past information 401 and current information 402 related to the vehicular travel of the other vehicle.

The past information 401 is information related to the vehicular travel and is stored and retained by the other vehicle in the memory thereof or the like. The past information 401 is, for example, the movement history related to the roads on which the other vehicle traveled in the past (such as the latitude and the longitude, the speed, and the time). In addition, when the other vehicle stores and retains ancillary information appended to the movement history, the navigating apparatus 300 also acquires the ancillary information.

Examples of the ancillary information include, for example, a history of visits to facilities and places (such as convenience stores, supermarkets, gasoline stations, and parking lots that are frequently used), favorite spots (such as registered places, and logos of the facilities that each are caused to be displayed on a route display screen when a visit is paid thereto in the past), entrances of parking lots (automatic parking memory location information), and information related to operation of direction indicators (the latitude and the longitude, and the direction of operation of the direction indicators).

The current information 402 is driving information of the other vehicle. Examples of the current information 402 include, for example, the current remaining gasoline amount of the other vehicle, the continuous driving time period, information related to sudden braking (such as presence or absence of any sudden braking, and the degree thereof) (the latitude and the longitude, and the degree of the sudden braking), collected information related to conversations of passengers in the vehicle, and the state of automatic driving. Regarding the continuous driving time period and the information related to conversations, such types of information related to the past retained by the other vehicle may be acquired without limitation to the information related to the current continuous driving.

The navigating apparatus 300 predicts the behavior of the other vehicle currently traveling in a vicinity of the user's vehicle (such as, for example, in front of the user's vehicle in the travel direction) based on the past information 401 and the current information 402 that can be acquired from the other vehicle. All the items included in the past information 401 depicted in FIG. 4 indicate behavior actually conducted by the other vehicle in the past. The navigating apparatus 300 can, therefore, use the past information 401 as is from the other vehicle in the prediction of the behavior of the other vehicle.

On the other hand, the current information 402 indicates the current state (the behavior) of the other vehicle. The navigating apparatus 300, therefore, for a portion of the current information 402 acquired from the other vehicle, executes a predetermined analysis process for the current information 402 before executing the prediction process.

For example, as to the remaining gasoline amount, the distance that can be travelled using the remaining gasoline amount is analyzed based on the fuel mileage of the other vehicle. In this case, the navigating apparatus 300 acquires fuel mileage information of the other vehicle, and analyzes the distance that can be travelled corresponding to the remaining gasoline amount. The navigating apparatus 300 executes the prediction process using the result of the analysis and, when the distance that can be travelled is shorter than a specific threshold value (or when the corresponding remaining gasoline amount is equal to a predetermined amount or less), predicts a gasoline station that can be reached in the travel direction.

Regarding the continuous driving time period, the prediction process is executed after executing analysis taking into consideration reductions in speed (stoppage) due to traffic congestion by executing an analysis based on the average speed that differs between a case of traveling on an ordinary road and a case of traveling on a highway. Regarding the information related to sudden braking, the prediction process is executed after analyzing the points at which the other vehicle executes sudden braking (the latitude and the longitude) and the degree of the sudden braking (the rate of the speed variation due to the sudden braking). The analysis may be executed further including the number of the sudden braking sessions executed at the same point in the past. Regarding the information related to conversations in the vehicle, the prediction process is executed after analyzing the contents of the conversation. Regarding the automatic driving state, the prediction process is executed after acquiring from the other vehicle, the state of the automatic driving of the other vehicle, for example, information related to the level of the automatic driving (such as, for example, levels 1 to 4).

Execution of these analyses is not limited to the execution by the navigating apparatus 300 and any apparatus on the other vehicle (such as, for example, a similar navigating apparatus 300) may execute the analyses and the navigating apparatus 300 of the user's vehicle may acquire the result of the analyses from the other vehicle and may use the result in the prediction process. For example, the remaining gasoline amount is information to be analyzed for subsequent travel of the other vehicle, and the result of the analysis by the other vehicle can be used. The sudden braking and the conversation information may also be analyzed for driving support at the other vehicle.

### Example of Communication by Inter-Vehicle Communication

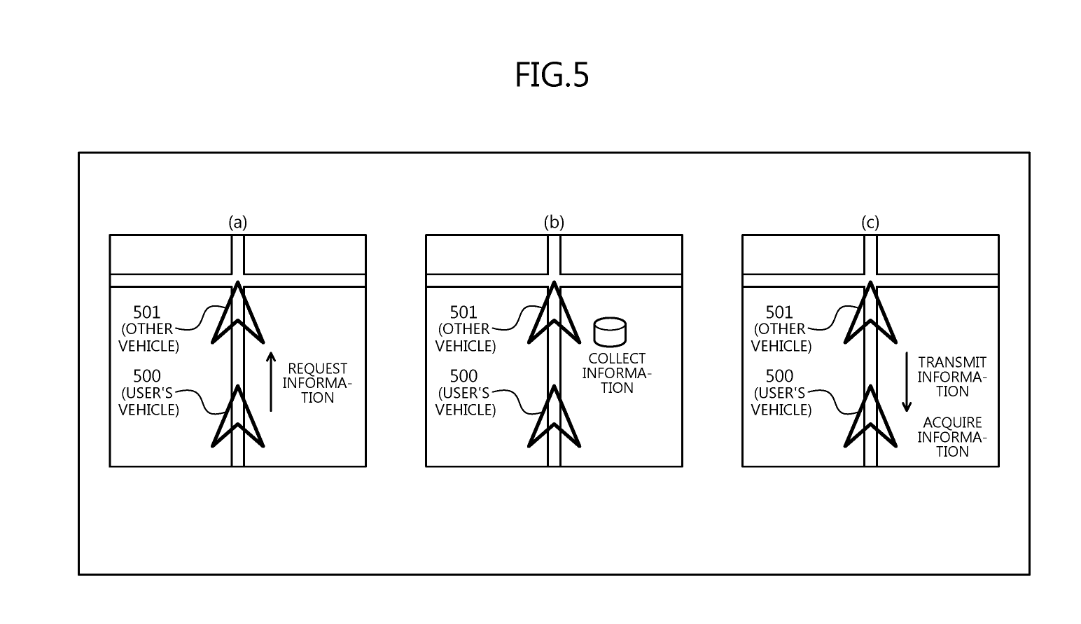

FIG. 5 is a chart for explaining an example of communication by the inter-vehicle communication according to Example. Improvement of the efficiency of the transmission and the reception of data by the inter-vehicle communication will be described with reference to FIG. 5. Communication traffic increases for the navigating apparatus 300 when the navigating apparatus 300 uses continuous communication to acquire from the other vehicle, the various types of information (see FIG. 4) for the prediction.

In Example, to prevent increases in the communication traffic of the inter-vehicle communication, as depicted in FIG. 5(a), the navigating apparatus 300 of the user's vehicle 500 first requests another vehicle 501, for example, for information to be used in the prediction. In this case, the navigating apparatus 300 of the user's vehicle 500 determines if communication has not yet been executed with the other vehicle 501 or communication has already been executed the other vehicle 501, based on the identification information related to the vehicle of the other vehicle 501, and the like. The navigating apparatus 300 of the user's vehicle 500 transmits the request for the information to the other vehicle 501 if no communication has been executed, while in the case where communication has already been executed, the navigating apparatus 300 of the user's vehicle 500 transmits the request for the information after a specific time period (such as, for example, after elapse of several minutes) from the previous communication.

In Example, the navigating apparatus 300 requests the other vehicle 501 to transmit thereto at least the movement history. As to the other types of information depicted in FIG. 4, for example, the navigating apparatus 300 requests the other vehicle 501 to transmit, for example, a portion of or all of the information collectable by the other vehicle 501.

As depicted in FIG. 5(b), after receiving the request, the other vehicle 501 collects the information usable in the prediction of behavior and transmits the collected information to the user's vehicle 500 (the navigating apparatus 300). In this case, when the information to be collected for use in the prediction of the behavior is defined in advance between the user's vehicle 500 and the other vehicle 501 (see, e.g., FIG. 4), the other vehicle 501 can collect and transmit information that corresponds with the request.

In this case, the other vehicle 501 transmits at least the information indicating the movement history to the user's vehicle 500. In addition, the other vehicle 501 also transmits collected information including the past information 401 and the current information 402. In this case, the data to be transmitted can also be narrowed to the data necessary for the prediction, by extracting and transmitting information related to the vicinity of the current position of the other vehicle 501. When the amount of data to be transmitted is large, the information related to the vicinity of the current position of the other vehicle 501 (an intersection in the example of FIG. 5) is extracted and transmitted. Alternatively, the amount of data can be reduced by transmitting a predetermined portion of the information.

As depicted in FIG. 5(c), the navigating apparatus 300 of the user's vehicle 500 can thereby acquire from the other vehicle 501, the information to predict the behavior of the other vehicle 501. When the navigating apparatus 300 of the user's vehicle 500 fails to acquire information from the other vehicle 501, navigating apparatus 300 again transmits the request to the other vehicle 501.

The inter-vehicle communication is not the only communication executed between the user's vehicle 500 and the one other vehicle 501, and the request by the user's vehicle 500 is transmitted by broadcasting to other vehicles 501 located within communication range of the inter-vehicle communication. Similarly, the other vehicles 501 also transmit by broadcasting the information for the prediction to the other vehicles 501 located within the communication range (including the user's vehicle 500).

After the user's vehicle 500 transmits the request, the user's vehicle 500 can select and discard pieces of information and thereby, receive from the other vehicle 501, only the information for the prediction, corresponding with the transmitted request. For example, the user's vehicle 500 attaches an identifier to the request and transmits the request to the other vehicle 501, whereby from the pieces of information received from the other vehicle 501, the user's vehicle 500 selects and receives only the pieces of information having the identifier included in the request.

### Example of Prediction of Behavior of Other Vehicle

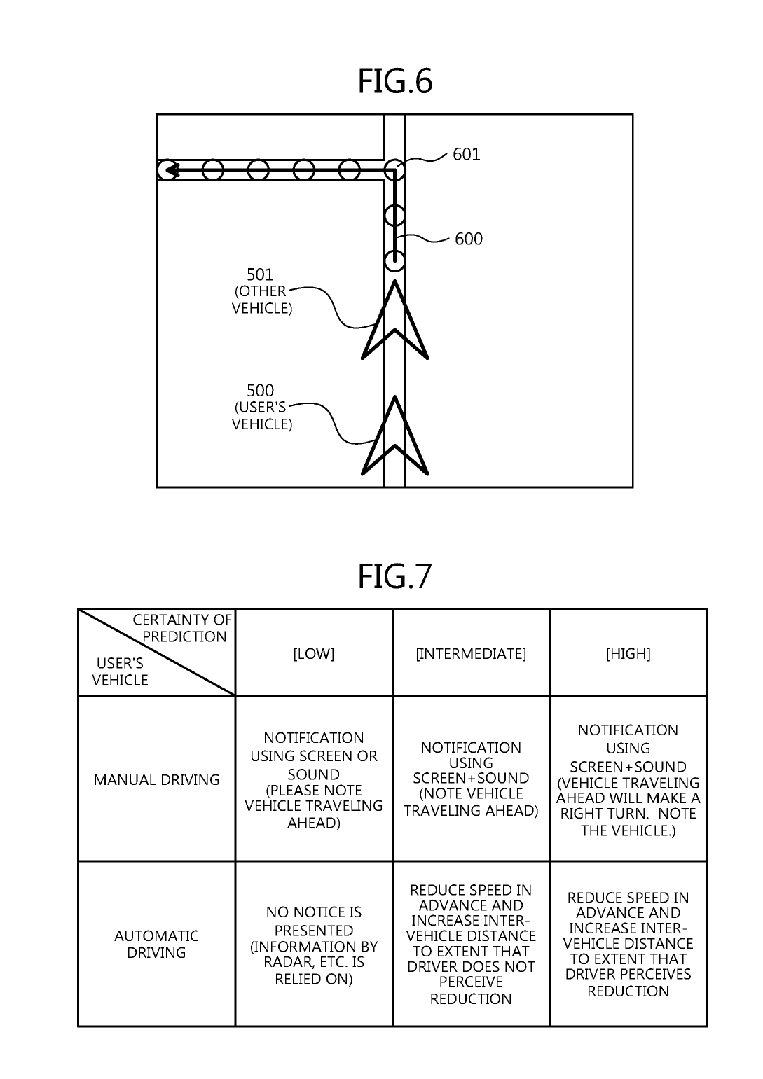

FIG. 6 is a diagram for explaining an example of the prediction of the behavior of the other vehicle according to Example. An example will be described where the navigating apparatus 300 of the user's vehicle 500 acquires the movement history of the other vehicle 501 and predicts the behavior of the other vehicle 501.

In the example depicted in FIG. 6, information indicating that in the past, the other vehicle 501 made a right turn at the next intersection 601 in the travel direction, is included as the contents of a movement history 600 (in FIG. 6, “o” indicates changes in the position of the other vehicle 501, for example, at each predetermined time period) acquired from the other vehicle 501, by the navigating apparatus 300 of the user's vehicle 500. In this case, the navigating apparatus 300 predicts that “the other vehicle 501 will make a right turn at the next intersection in the traveling direction” as the behavior of the other vehicle 501, based on the acquired movement history. The navigating apparatus 300 does not output the movement history depicted in FIG. 6 at the time point at which the movement history 600 is acquired (before executing the prediction process).

When time information is appended to the movement history 600, the navigating apparatus 300 can acquire the degree of certainty of the prediction based on the time at which the other vehicle 501 made, in the past, the right turn indicated by the movement history 600 and the current time.

When the time at which the other vehicle 501 made the right turn in the past is close to the current time, the degree of certainty of the prediction is high. The degree of certainty of the prediction decreases as the time at which the other vehicle 501 made the right turn in the past increasingly differs from the current time. For example, when the time at which the other vehicle 501 made the right turn in the past is in a commute time period in the morning (such as, for example, 8:00 a.m.) and the current time is substantially same as this time (7:55 a.m.), the degree of certainty of the prediction is high. On the other hand, when the current time is a time in the afternoon (1:15 p.m.), the degree of certainty of the prediction is lower. When the current time is a time in the evening (6:30 p.m.), the degree of certainty of the prediction is even lower.

The acquired movement history 600 of the other vehicle 501 can determine the degree of certainty of the prediction based on the frequency of each travel direction at the intersection 601. For example, when the rate of the number of the right turns made by the other vehicle 501 at the intersection 601 is high, the degree of certainty of the prediction for a right turn can be increased. The degree of certainty of the prediction can further be increased by combining the frequency and the time.

The navigating apparatus 300 outputs the behavior of the other vehicle 501 predicted as the driving support information. For example, the navigating apparatus 300 outputs the predicted behavior as the driving support information to the driver of the user's vehicle 500. In this case, the navigating apparatus 300 displays that the other vehicle 501 makes a right turn at the intersection 601, on the display screen as prediction information 600 related to the behavior of the other vehicle 501. The prediction information 600 is same as a traveling locus 600 while, as depicted in FIG. 6, the navigating apparatus 300 outputs by displaying on the display screen the prediction information 600 for the first time after the prediction. Concurrently with the display, the navigating apparatus 300 may output the prediction information 600 using characters or a sound as “the other vehicle (the vehicle running ahead) will make a right turn at the next intersection” or the like.

The driver of the user's vehicle 500 can thereby take measures such as slowing-down the user's vehicle 500 to increase, in advance, the inter-vehicle distance with the other vehicle 501 at a timing before the other vehicle 501 reduces its speed and operates its direction indicator at the intersection 601, based on the display and the like of the prediction information executed by the navigating apparatus 300. In this manner, subsequent behaviors of the other vehicle 501 are predicted and the behaviors of the other vehicle 501 are notified to the driver of the user's vehicle 500 at the timing before the other vehicle 501 actually executes the behavior, enabling the driver of the user's vehicle 500 to execute proper driving operation at a timing before an actual behavior of the other vehicle 501 occurs, facilitating a safer driving.

The navigating apparatus 300 may output to the vehicle control unit of the user's vehicle 500, the prediction information 600 related to the behavior of the other vehicle 501. In this case, the vehicle control unit can execute driving control such as slowing-down the user's vehicle 500 to increase, in advance, the inter-vehicle distance with the other vehicle 501 at a timing before the other vehicle 501 reduces its speed and operates its direction indicator at the intersection 601.

In the above behavior prediction, the navigating apparatus 300 may acquire the road information from the other vehicle 501 when the other vehicle 501 sets a route. Even when the other vehicle 501 sets the route, the other vehicle 501 may not travel along the set route. In the example of FIG. 6, even when the route is set to make a right turn at the intersection 601, a case can be considered where the other vehicle 501 actually travels straight or actually makes a left turn.

In this case, the navigating apparatus 300 predicts the behavior of the other vehicle 501 using the various types of information (see FIG. 4) acquired from the other vehicle 501 and the set route information in combination. At least the movement history of the other vehicle 501 has predetermined reliability and the navigating apparatus 300 predicts and determines the behavior using the movement history and the route information in combination. The navigating apparatus 300 can thereby predict the behavior of the other vehicle 501 as correctly as possible with a degree of certainty regardless of the presence or absence of a route set by the other vehicle 501.

The navigating apparatus 300 can improve the precision of the prediction by acquiring from the other vehicle 501, the movement history for the past and further combining the acquired movement history with the other types of information. Examples of the other types of information include, as depicted in FIG. 4, the ancillary information of the movement history (the past information 401) and the driving information (the current information 402). The degree of certainty of the prediction can be set to be higher as the number of the other types of information to be combined with the movement history increases.

For example, in the automatic driving state, when the route is set as the other types of information to be acquired from the other vehicle 501, the navigating apparatus 300 determines as the behavior of the other vehicle 501 that the other vehicle 501 travels along the route. In this case, the degree of certainty of the prediction is high. On the other hand, during the manual driving, even when the route information is acquired from the other vehicle 501 as above, the other vehicle 501 may not travel along the route and the degree of certainty of the prediction is low. For the manual driving, the degree of certainty can therefore be increased by acquiring plural types of information.

The analysis process executed before executing the prediction, for the other types of information acquired from the other vehicle 501 will be described taking, as an example, a case of the continuous driving time period. When the other vehicle 501 has continuously driven for a predetermined time period (such as, for example, two hours) or longer on a highway or the like, the navigating apparatus 300 predicts that “the other vehicle 501 will visit the next service area (SA) or the next parking area (PA) to take a rest” as the behavior of the other vehicle 501.

In this case, the navigating apparatus 300 executes a predetermined analysis regarding an increase in the time period for stoppage in the continuous driving time period, due to traffic congestion. For example, the navigating apparatus 300 refers to a road map for the stoppage due to traffic congestion on a highway, and determines for the stoppage on the highway that the other vehicle 501 is located in the congested zone and includes the time period for the stoppage in the continuous driving time period, obtaining an analysis result that the stoppage is not to take a rest (not the end of the continuous driving time period). In addition, when the navigating apparatus 300 determines that the other vehicle 501 is located in the congested zone based on an externally acquired beacon and traffic congestion information, the navigating apparatus 300 includes the time period for the stoppage in the continuous driving time period, obtaining an analysis result that the stoppage is not to take a rest (not the end of the continuous driving time period). The degree of certainty of the prediction executed thereafter can be increased by executing such analyses.

The analysis process executed before executing the prediction, for the other types of information acquired from the other vehicle 501 will be described taking an example of a case for information related to a conversation in the other vehicle 501. The other vehicle 501 transmits to the user's vehicle 500, information related to conversation, collected inside the other vehicle 501 (sound data). The navigating apparatus 300 of the user's vehicle 500 analyzes the sound of the acquired conversation information and uses the result in the prediction of a behavior. For example, the navigating apparatus 300 analyzes the sound of the conversation of “I would like to visit a convenience store” in the other vehicle 501, and predicts that the other vehicle will visit the next convenience store on the traveling route of the user's vehicle 500. When the user's vehicle 500 approaches the next convenience store, the navigating apparatus 300 outputs to the driver of the user's vehicle, the predicted behavior of the other vehicle (the behavior conducted when the other vehicle visits the next convenience store) using the display on the screen, a sound, and the like. This sound analysis may be executed by the other vehicle 501 and the navigating apparatus 300 of the user's vehicle 500 may execute the prediction for the other vehicle 501 based on the result of the sound analysis.

### Example of Driving Support Corresponding to Degree of Certainty of Prediction

FIG. 7 is a chart for explaining an example of the driving support corresponding to the degree of certainty of the prediction according to Example. A vertical axis represents the driving state of the user's vehicle 500 and a horizontal axis represents the degree of certainty of the prediction of the behavior the other vehicle 501. Types of driving states of the user's vehicle 500 include the manual driving and the automatic driving. For the manual driving, the output contents to be notified to the driver by the navigating apparatus 300 are depicted. For the automatic driving, the control contents executed by the vehicle control unit are depicted.

The degree of certainty of the prediction of the behavior can be determined in according to, for example, the number of types of information that can be acquired from the other vehicle 501. The degree of certainty can also be determined based on whether the other vehicle 501 is in the automatic driving state or the manual driving state. For example, when the type of information that can be acquired from the other vehicle is only one type of information that is the movement history, the degree of certainty is determined to be “low”. When the types of information that can be acquired from the other vehicle are the movement history and one or more type(s) of information, the degree of certainty is determined to be “intermediate”. The degree of certainty may be increased within the range of the intermediate degree of certainty as the number of other types of information increases. When the information that can be acquired from the other vehicle is the automatic traveling, the traveling route is determined even when the movement history is absent, and the degree of certainty is, therefore, determined to be “high”. When the types of information that can be acquired from the other vehicle do not include the movement history (including a case where plural types of information other than the movement history are present), the degree of certainty is determined to be “lowest” and configuration may be such that no output of the driving support information (no prediction of the behavior) is executed.

When the degree of certainty of the prediction of the behavior of the other vehicle 501 is “low”, for the manual driving, the navigating apparatus 300 presents the notification using the display screen or sound. The notification is presented at a weakened level stating, for example, “please note the other vehicle (the vehicle running ahead)”. For the automatic driving, the vehicle control unit does not execute any vehicle control based on the prediction because the degree of certainty of the behavior of the prediction is “low”, and executes the vehicle control based on another device for the vehicle control such as the radar.

When the degree of certainty of the prediction of the behavior of the other vehicle 501 is “intermediate”, for the manual driving, the navigating apparatus 300 presents the notification using the display screen and sound in combination. For example, the navigating apparatus 300 causes the driver to give attention by presenting the notification stating “please note the other vehicle”. In the example of FIG. 6, the notification is presented stating “the other vehicle (the vehicle running ahead) will make a right turn at the next intersection”. For the automatic driving, the vehicle control unit executes the vehicle control based on the prediction whose degree of certainty of the prediction of the behavior is “intermediate”. For example, the speed can be caused to be reduced (braking using the brake) to an extent that the driver does not perceive the reduction in advance (at a timing before the other vehicle 501 executes the behavior) and, in addition, the control to increase the inter-vehicle distance with the other vehicle 501 (braking using the brake, a change of the lane, and the like) can be executed.

When the degree of certainty of the prediction of the behavior of the other vehicle 501 is “high”, for the manual driving, the navigating apparatus 300 presents a notice using the display screen and sound in combination. For example, the navigating apparatus 300 actively notifies of the predicted behavior to the driver stating “please note the other vehicle (the vehicle running ahead)”. In this case, the navigating apparatus 300 causes the display on the screen to be emphasized. In addition, the navigating apparatus 300 may present the notification more strongly emphasizing the notification by outputting the notification with an increased sound volume. For the automatic driving, the vehicle control unit executes the vehicle control based on the prediction whose degree of certainty of the prediction of the behavior is “high”. For example, the speed can be caused to be reduced (braking using the brake) to an extent that the driver can perceive the reduction in advance (at a timing before the other vehicle 501 executes the behavior). In this case, the control to increase the inter-vehicle distance with the other vehicle 501 (braking using the brake, a change of the lane, and the like) can also be executed.

### Example of Prediction Process of Behavior of Other Vehicle

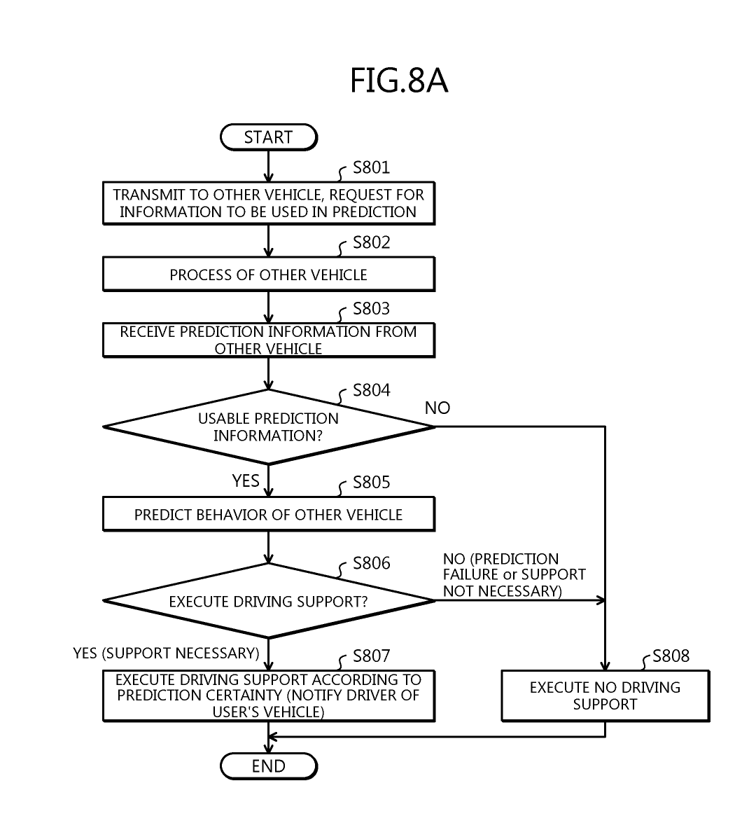

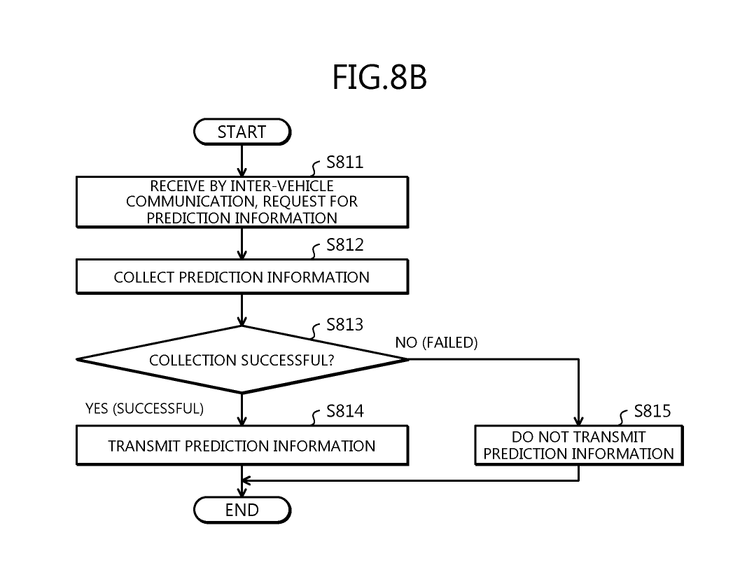

FIG. 8A is a flowchart of an example of the prediction process executed by the user's vehicle according to Example. The navigating apparatus 300 of the user's vehicle 500 first transmits to the other vehicle 501, a request for information to be used in the prediction of the behavior of the other vehicle 501 using the inter-vehicle communication (step S801). The other vehicle receives the request from the user's vehicle 500 and executes a process (FIG. 8B) such as collection of the information to be used in the prediction by the user's vehicle 500 (step S802).

The navigating apparatus 300 of the user's vehicle 500 receives from the other vehicle 501 by the inter-vehicle communication, the information to be used in the prediction of the behavior of the other vehicle (step S803). The navigating apparatus 300 determines whether the received information is information usable in the prediction of the behavior of the other vehicle 501 (step S804). When the navigating apparatus 300 determines that the received information is usable in the prediction of the behavior of the other vehicle 501 (step S804: YES), the navigating apparatus 300 predicts the behavior of the other vehicle 501 (step S805). The information usable in the prediction of the behavior of the other vehicle 501 is, for example, the various types of information depicted in FIG. 4, and needs to include at least the information related to the movement history.

When the navigating apparatus 300 determines that the received information is not usable in the prediction of the behavior of the other vehicle 501 (step S804: NO), the procedure moves to step S808. The information not usable in the prediction of the behavior of the other vehicle 501 is, for example, various types of information other than those depicted in FIG. 4. When the transmitted information does not include the information related to the movement history, the navigating apparatus 300 may determine that the information is not usable in the prediction of the behavior of the other vehicle 501.

After predicting the behavior of the other vehicle 501 at step S805, the navigating apparatus 300 determines whether the navigating apparatus 300 executes the driving support for each degree of certainty of the prediction (step S806). When the navigating apparatus 300 fails in the prediction or the degree of certainty is “lowest” (step S806: NO), the procedure moves to step S808. When the prediction process can be executed and the degree of certainty is “low” or higher, the navigating apparatus 300 determines to execute the driving support (step S806: YES) and the procedure moves to step S807.

At step S807, the navigating apparatus 300 executes the driving support for the user's vehicle 500 (step S807). In this case, the navigating apparatus 300 presents the notification using the display and the sound to the driver of the user's vehicle as depicted in FIG. 7. The navigating apparatus 300 can also execute the control of the automatic driving executed by the vehicle control unit.

At step S808, that is, a case where the prediction cannot be executed or where the degree of certainty of the prediction is “lowest”, the prediction is not usable for the driving support and the navigating apparatus 300, therefore, executes no driving support (step S808). After the operations at steps S807 and S808 executed at the user's vehicle 500, the navigating apparatus 300 of the user's vehicle 500 causes the above operations to come to an end.

FIG. 8B is a flowchart of an example of a process executed by the other vehicle, according to the prediction process of Example. The process executed by the other vehicle 501 may be executed by a predetermined control unit that has a function of the inter-vehicle communication, or may be executed by an apparatus that has a same function as that of the navigating apparatus 300 of the user's vehicle 500.

The other vehicle 501 receives from the user's vehicle 500 by the inter-vehicle communication, the request for information to be used in the prediction of the behavior (step S811). At the other vehicle 501, the following operation steps are also executed by, for example, an apparatus having a function equivalent to that of a navigating apparatus 300 equivalent to that of the user's vehicle 500 (having a configuration to retain at least the movement history and capable of transmission to the user's vehicle 500 by the inter-vehicle communication).

The other vehicle 501 collects the information that is to be used in the prediction of the behavior and that can be transmitted in response to the request (step S812). In this case, the other vehicle 501 collects the various types of information such as the past information 401 and the current information 402 (see FIG. 4) stored in the memory or the like.

The other vehicle 501 determines whether collection of the information to be used in the prediction of the behavior is successful (step S813). When the other vehicle 501 determines that the collection is successful (step S813: YES), the procedure moves to step S814. When the other vehicle 501 determines that the collection has failed (step S813: NO), the procedure moves to step S815. As above, at least the movement history of the other vehicle 501 is necessary as the information to be used in the prediction of the behavior and, when the movement history is not present, the other vehicle 501 determines that the collection has failed.

At step S814, the other vehicle 501 transmits to the user's vehicle 500, the successfully collected information to be used in prediction (step S814). This information to be used in prediction includes at least the movement history of the other vehicle 501. At step S815, because the other vehicle 501 fails in the collection, the information to be used in prediction is not transmitted to the user's vehicle 500 (step S815). After the operations at steps S814 and S815, the other vehicle 501 causes the above operations executed thereby to come to an end.

### Another Example of Configuration of Predicting Apparatus

In Example, an example of a configuration in which the navigating apparatus 300 of the user's vehicle 500 functions as the predicting apparatus has been described. Without limitation hereto, an external apparatus may execute the prediction of the behavior of the other vehicle 501 executed by the predicting apparatus.

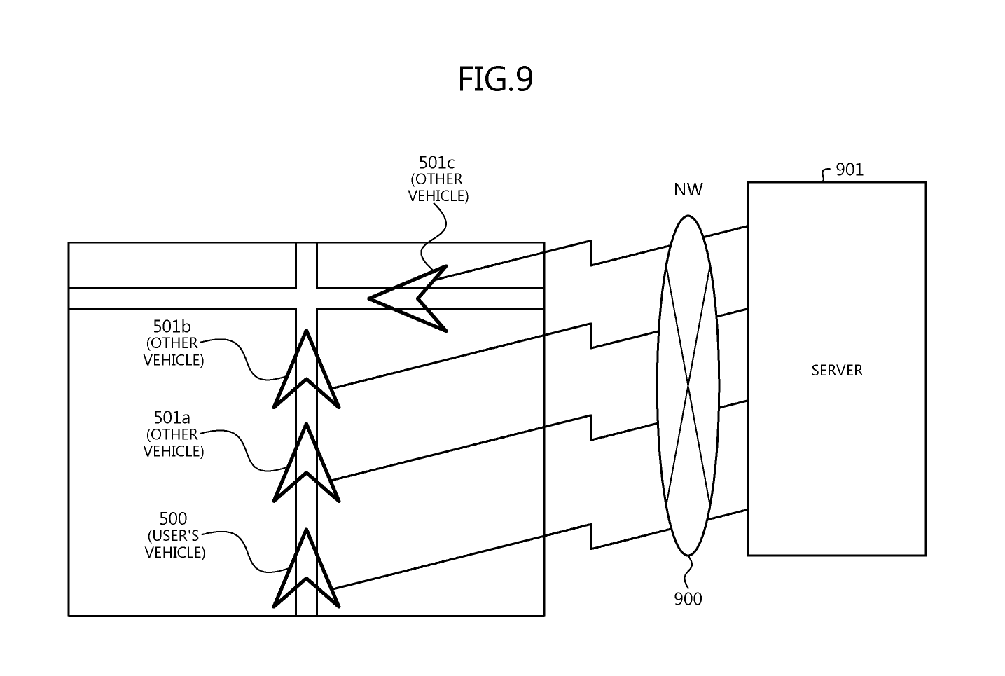

FIG. 9 is a diagram of an example of a system configuration of the predicting apparatus according to Another Example. The user's vehicle 500 and the other vehicles 501 (501a to 501c) may each have a configuration equivalent to that of the navigating apparatus 300. The user's vehicle 500 transmits the current position of the user's vehicle 500 to a server 901 through a network (NW) 900. The other vehicle 501 transmits the current position thereof and the information to be used in the prediction of the behavior including the movement history for the past (see FIG. 4) to the server 901 through the NW 900. The server 901 predicts the behavior of the other vehicle 501 based on the movement history and the like received from the other vehicles 501 located around the user's vehicle 500 corresponding to the current position of the user's vehicle 500, and transmits the result of the prediction to the user's vehicle 500 through the NW 900.

When the configuration is employed in which the user's vehicle 500 and the other vehicle 501 are network-connected to the server 901, the server 901 sequentially detects the current position of each of the vehicles. As depicted in FIG. 9, even when the other vehicle 501 is present in plural, the server 901 can identify the user's vehicle 500 and the plural other vehicles 501 with a predetermined precision for location. The server 901 can identify the vehicles further using identification information specific to each of the vehicles and radio identification information, can also predict the behaviors of each of the plural other vehicles 501 relative to the user's vehicle 500, and can also notify the user's vehicle 500 of the predicted behaviors. For example, the server 901 can predict the behavior of the other vehicle 501a in the same travel direction as that of the user's vehicle 500 and that of the other vehicle 501c approaching the user's vehicle 500 from a different direction, distinguishing these vehicles from each other.

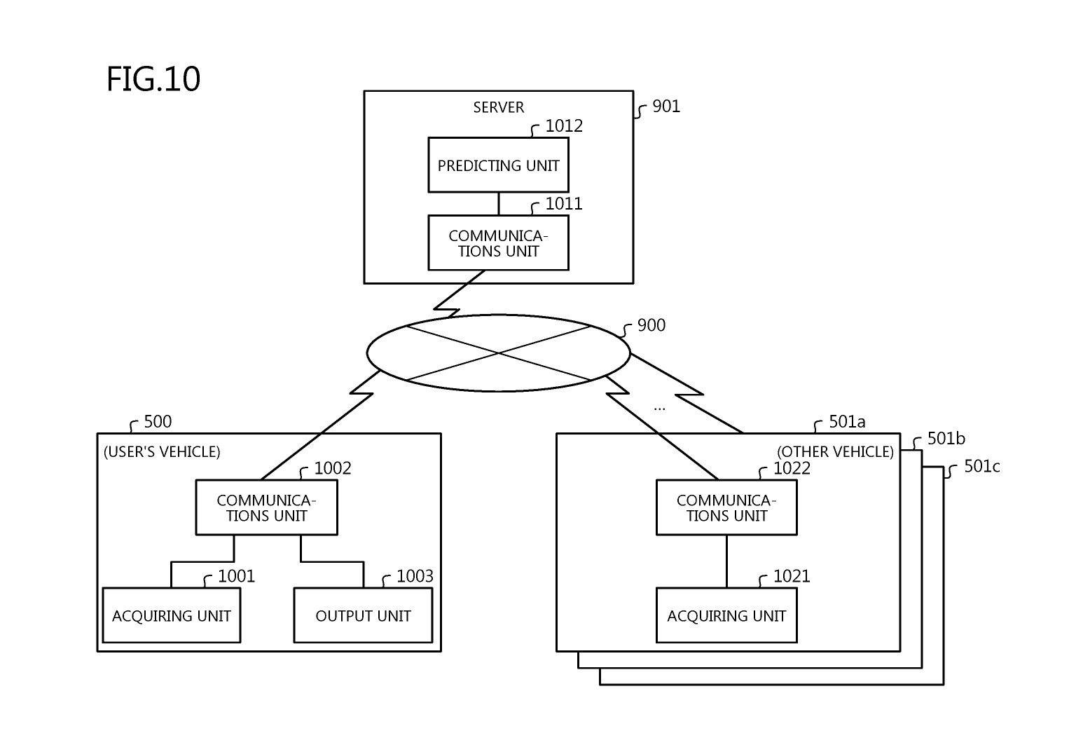

FIG. 10 is a diagram of an example of a functional configuration of the system of the predicting apparatus according to Another Example. The user's vehicle 500 and the other vehicles 501 can each be configured to, for example, include the navigating apparatus 300.

The user's vehicle 500 includes an acquiring unit 1001 that acquires the current position, a communications unit 1002 that transmits the current position to the server 901, and an output unit 1003 that receives a result of the prediction prediction-processed by the server 901 through the communications unit 1002 and outputs the result by display and the like.

The other vehicles 501 each includes an acquiring unit 1021 that acquires the information to be used in the prediction of the behavior (see FIG. 4) including the movement history for the past, and a communications unit 1022 that transmits information such as the movement history to the server 901. When the same configuration as that of the user's vehicle 500 is also employed by the other vehicle 501, the prediction of the behavior of the counterpart can be mutually received from the server 901.

The server 901 can include a communications unit 1011 that transmits and receives information to/from each of the user's vehicle 500 and the other vehicles 501, and a predicting unit 1012. The predicting unit 1012 has a function same as that in FIG. 1, predicts the behavior of the other vehicles 501, and transmits the result of the prediction to the user's vehicle 500.

With the above configuration, when the user's vehicle 500 requests the server 901 for the prediction of the behaviors of the other vehicles 501 , the server 901 also predicts the behaviors of the other vehicles 501 based on the movement history and the like, and transmits the result of the prediction to the user's vehicle 500.

In this manner, in Another Example, the user's vehicle 500 and the other vehicles 501 each transmits to the server 901 at the center, the information necessary for the prediction of the behaviors of the other vehicles 501. Thus, the server 901 executes the prediction process bearing a predetermined load therefor, whereby the processing burden on the user's vehicle 500 and the other vehicles 501 can be alleviated. The pieces of information related to the plural other vehicles 501 concentrate at the server 901 and the behaviors of the plural other vehicles 501 relative to the user's vehicle 500 can therefore be collectively prediction-processed, and the information can be presented to the user's vehicle 500. The prediction process can be executed without executing any inter-vehicle communication by which the user's vehicle 500 and the other vehicles 501 directly communicate with each other.

Examples described above each have been described taking, as an example, while a configuration in which the navigating apparatus is used as the predicting apparatus and the navigating apparatus is equipped on the mobile object (the vehicle), the vehicle having the predicting apparatus (the navigating apparatus) equipped thereon is not limited to a vehicle, and a bicycle or a motorbike can also have the predicting apparatus equipped thereon.

While examples have also been described as a configuration in which the navigating apparatus is disposed in each of the user's vehicle and the other vehicles, a terminal device such as a smartphone or a tablet is usable.

The predicting method described in the present embodiment may be implemented by executing a prepared program on a computer such as a personal computer and a workstation. The program is stored on a computer-readable recording medium such as a hard disk, a flexible disk, a CD-ROM, an MO, and a DVD, read out from the computer-readable medium, and executed by the computer. The program may be distributed through a network such as the Internet.

### EXPLANATIONS OF LETTERS OR NUMERALS

100 predicting apparatus
101, 1001, 1021 acquiring unit
102,1012 predicting unit
103,1003 output unit
300 navigation apparatus
301 CPU
302 ROM
303 RAM
500 user's vehicle
501 other vehicle
901 server
1001, 1021 acquiring unit
1002, 1011, 1022 communications unit

1. A predicting apparatus comprising:
an acquiring unit that acquires a movement history of a mobile object from the mobile object;
a predicting unit that predicts a behavior of the mobile object and a degree of certainty of the behavior, based on the movement history; and
an output unit that outputs driving support information that is based on the behavior and the degree of certainty.

2. The predicting apparatus according to claim 1, wherein
the output unit changes the driving support information to contents corresponding to the degree of certainty.

3. The predicting apparatus according to claim 1, wherein
the output unit performs output in a state that corresponds to the degree of certainty.

4. The predicting apparatus according to claim 3, wherein
the state of output by the output unit is display and sound when the degree of certainty is high, and is any one of display and sound when the degree of certainty is low.

5. The predicting apparatus according to claim 1, wherein
the acquiring unit acquires the movement history from the mobile object in a communication range of inter-vehicle communication, and
the predicting unit predicts the behavior and the degree of certainty of the behavior of the mobile object in the communication range of the inter-vehicle communication.

6. The predicting apparatus according to claim 1, wherein
the output unit is capable of outputting the driving support information to a vehicle control unit of a mobile object on which the predicting apparatus is equipped.

7. The predicting apparatus according to claim 1, wherein
the degree of certainty is obtained based on a current time and a past time of a right or left turn, or based on a frequency of travel directions at an intersection, in the movement history.

8. A prediction system comprising:
a user's vehicle;
another vehicle; and
a server, wherein
the user's vehicle, the other vehicle, and the server are communicably connected to each other, and
the server includes:
an acquiring unit that acquires a current position of the user's vehicle and a movement history of the other vehicle;
a predicting unit that predicts a behavior of the other vehicle and a degree of certainty of the behavior, based on the current position and the movement history; and
an output unit that outputs to the user's vehicle, driving support information that is based on the behavior and the degree of certainty.

9. A prediction method executed by a predicting apparatus, the prediction method comprising:
an acquiring step of acquiring a movement history of a mobile object from the mobile object;
a predicting step of predicting a behavior of the mobile object and a degree of certainty of the behavior, based on the movement history; and
an output step of outputting driving support information that is based on the behavior and the degree of certainty.

10. A non-transitory, computer-readable recording medium storing therein a prediction program that causes a computer to execute the prediction method according to claim 9.
